(19) United States
(12) Patent Application Publication
(10) Pub. No.: US 2026/0237938 A1
(43) Pub. Date: Aug. 13, 2026

(54) Plug Connector Having A Strain Relief Element

(71) Applicant: HIRSCHMANN AUTOMOTIVE GMBH, Rankweil/Brederis (AT)

(72) Inventors: Julian IMMLER, Altach (AT); Raphael HOOR, Feldkrich (AT)

(21) Appl. No.: 19/155,778

(22) PCT Filed: Feb. 9, 2024
(86) PCT No.: PCT/EP2024/053380

§ 371 Date: Aug. 12, 2025

(30) Foreign Application Priority Data
Feb. 17, 2023 (DE) 10 2023 103 984.9

(51) Int. Cl. H01R 13/58

(52) U.S. Cl. CPC H01R 13/5825

(57) ABSTRACT

The invention relates to a plug connector having a strain relief element, wherein: each contact (2) of the plug connector is disposed in a contact chamber of a contact carrier (3); each contact (2) is fastened to the end of an electrical conductor of a cable (1); tensile and/or compressive forces which can act on the contact (2) via the cable (I) are largely or completely kept away from the contact (2) by means of the strain relief element; a sleeve (5) is provided, into which the contact carrier (3) is inserted; a first and last one additional strain relief component (61, 62) are inserted within the sleeve (5); the inner contour of the at least two strain relief components (61, 62) acts on the at least one cable (I), preferably a plurality of cables (1), and the strain relief components (61, 62) are supported on the contact carrier (3) by means of the sleeve (5) so that tensile and/or compressive forces acting on the at least on cable (1) are kept away from the contacts (2).

The invention relates to a plug connector having a strain relief element according to the features of the preamble of claim 1.

Plug connectors having strain relief elements are known, wherein the strain relief element causes tensile and/or compressive forces that can act on a contact via a cable to be largely or completely prevented from the contact. The respective contact of the plug connector is arranged in a contact chamber of a contact carrier, wherein the respective contact is fastened to the end of an electrical conductor of a cable. In addition, the contact carrier is arranged in a housing.

The invention is based on the object of improving such a plug connector, in particular with regard to its assembly as well as with regard to the strain relief effect.

This object is achieved by the features of claim 1.

According to the invention, a sleeve is provided into which the contact carrier is inserted, wherein a first and at least one further, in particular exactly one second, strain relief component is inserted within the sleeve, wherein the inner contour of the at least two or exactly two strain relief components acts on the at least one cable, preferably a plurality of cables, and the strain relief components are supported on the contact carrier by means of the sleeve, so that tensile and/or compressive forces acting on the at least one cable are kept away from the contacts.

If exactly two strain relief components are used, this results in a particularly uniform pressure effect on the cable inserted between them when pressure is exerted on the two strain relief components by pressing the sleeve. In a particularly advantageous manner, the two strain relief components are designed identically so that the number of differently designed strain relief components is significantly reduced.

The strain relief components preferably consist of plastic and are manufactured in a plastic injection molding method. The sleeve can also consist of plastic. Alternatively, it can be made of a metallic material if the plug connector is required to have shielding properties.

The strain relief components are arranged in the sleeve in such a way that they exert pressure on the at least one cable so that this is fixed by means of a press fit in the sleeve for the purpose of strain relief. The press fit can also be achieved in that the sleeve consists of metal and is deformed, for example crimped, at least regionally after the insertion of the strain relief components. A crimping process has the advantage that it can be carried out very precisely and automatically with regard to a defined deformation of the sleeve.

A first exemplary embodiment and further alternative embodiments thereof are shown in the figures and described below.

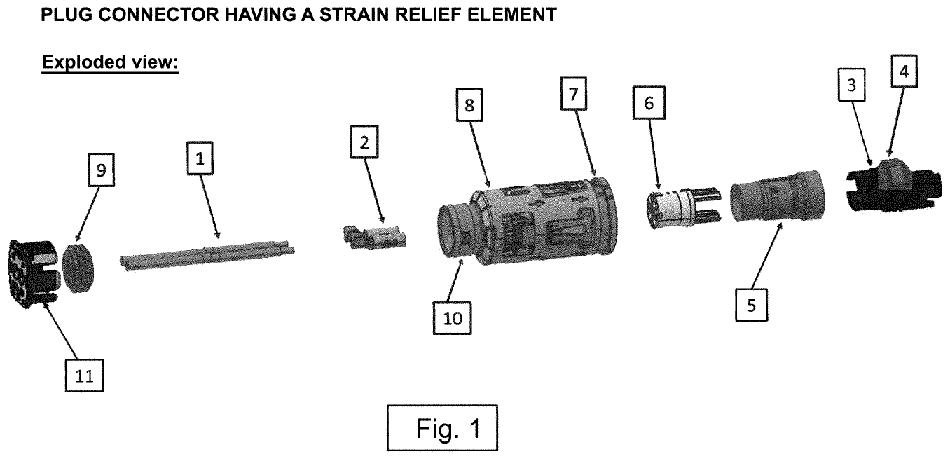

FIG. 1 shows a plug connector in an exploded view, which is connected to at least one cable 1 (two cables are shown here, there can also be more than two cables). The plug connector comprises contacts 2 which are inserted into corresponding contact chambers of a contact carrier 3. Furthermore, there can be a latch 4 which is actuated when the contacts 2 have been inserted into their respective contact chambers of the contact carrier 3. This is a known primary lock. Furthermore, the plug connector has a sleeve 5 (of plastic or of metal) into which a strain relief element 6, consisting of a plurality of components (to be be described later), can be inserted. The sleeve 5 is inserted with its contact carrier 3 into an outer housing 7, wherein the outer housing 7 can be surrounded by a shielding cage 8, but does not have to be. Furthermore, a seal 9 is provided which can be inserted into one end 10 of the outer housing 7. In addition, a sealing plug 11 is provided which fixes the seal 9 in the end 10 of the outer housing 7 and through which the cables 1 are passed.

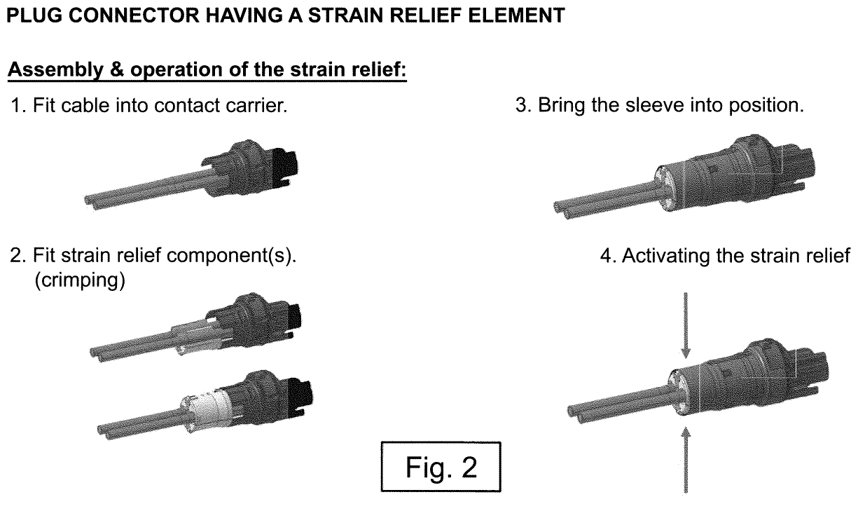

FIG. 2 shows the assembly and operation of the strain relief. It can be seen here that exactly two components of the strain relief element 6 are inserted into the sleeve 5, wherein the sleeve 5 is mechanically deformed, in particular pressed or clamped, so that the components of the strain relief element 6 exert pressure on the at least one cable 1, which in turn causes strain and/or pressure relief of the contacts 2 in the contact carrier 3. In this shown assembly sequence, the contacts 2 are first arranged at the ends of their respective cables 1, and the contacts 2 are inserted into the contact chambers of the contact carrier 3. The strain relief components of the strain relief element 6 are then mounted, and the sleeve 5 is pushed over them and preferably fastened to the contact carrier 3. The strain relief is then activated, for example in that the sleeve 5, which consists of metal, is mechanically deformed, e.g., crimped. The at least one cable 1 is either inserted into the strain relief element 6 and together with it into the sleeve, or the strain relief element 6 is inserted into the sleeve 5, and then the at least one cable is inserted through the strain relief element 6 inserted into the sleeve 5.

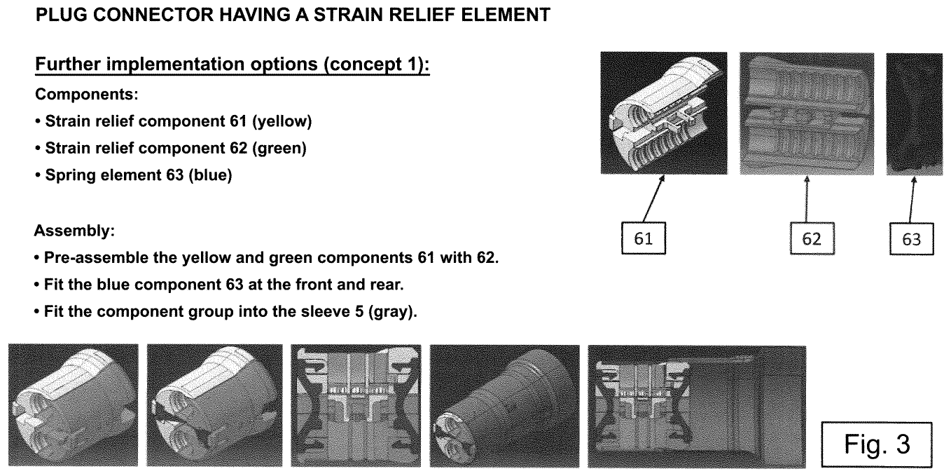

FIG. 3 shows a first concept of how the strain relief components can be designed. In this case, two components 61, 62 are shown which have an inner contour with elevations and depressions which alternate in the axial course in order to cause a good contact with the outer sheath of the cables 1 when they are enclosed by the two components 61, 62 under the influence of pressure. The two components 61, 62 are held together by means of at least one spring element 63, preferably by means of two spring elements 63 as shown.

The assembly is carried out, for example, by pre-assembling one component 61 with the other component 62. Then one component 63 is fitted at the front and one at the rear (alternatively only one component 63, which is fitted from the front or rear). This group of components is then fitted into the sleeve 5.

After the two components 61 and 62 have been brought together by means of the at least one spring element 63, the cables 1 (optionally only one cable or more than two cables) can be passed through here and inserted into the sleeve 5. After the cables 1 have been passed through, the sleeve 5 is mechanically deformed so that pressure is applied to the cables 1 by means of the components 61, 62 in order to relieve them. Alternatively, the assembly sequence described in FIG. 2 can be used.

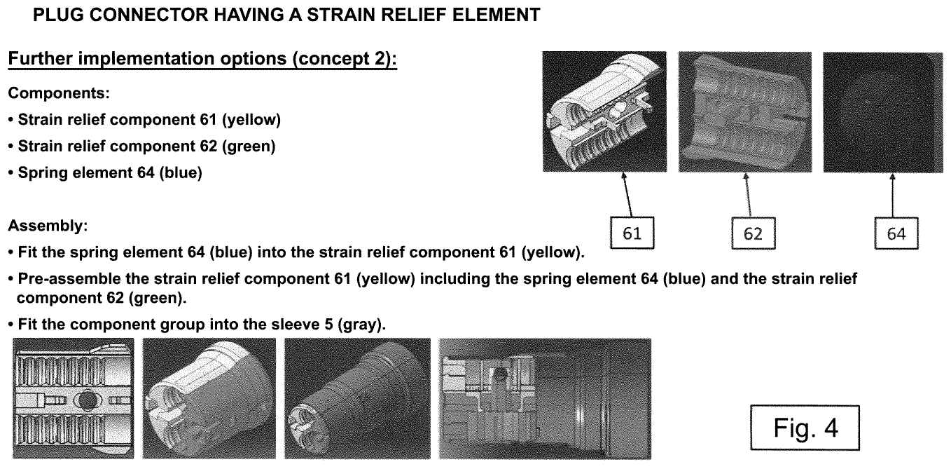

FIG. 4 shows a second concept, wherein the two components 61, 62 are designed in exactly the same way as in the first concept. However, in this case, the spring element 64 is designed as a ball, which causes the two components 61 and 62 to be unable to move relative to each other when they are inserted together into the sleeve 5. Further assembly is carried out as described above for FIG. 3.

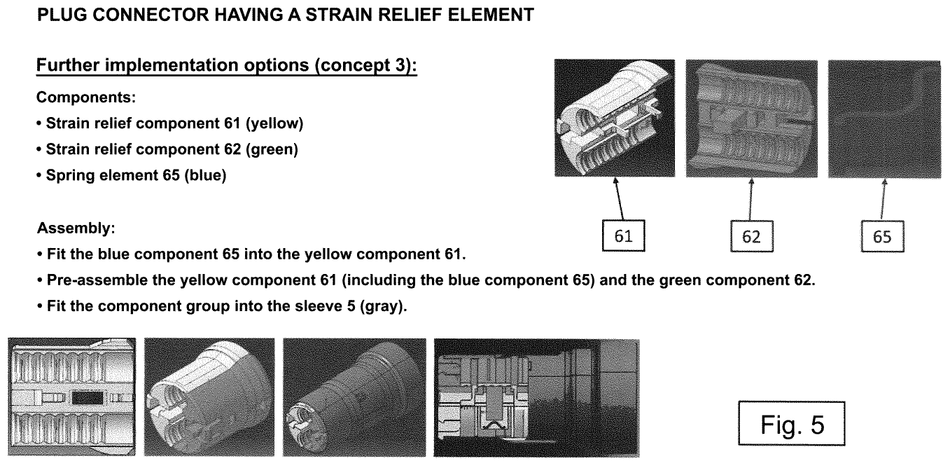

FIG. 5 shows a third concept for strain relief, wherein in this case the spring element 65 is designed wave-shaped and also, upon its insertion, causes the two components 61, 62 are held together when they are inserted into the sleeve 5. Further assembly is carried out as described above for FIG. 3.

What the spring elements 63, 64 and 65 have in common is that they not only hold the two components 61, 62 together when they are pushed into the sleeve 5 together, but that after insertion, they can also (but do not have to) cause the components 61, 62 to rest against the inner contour of the sleeve 5 under spring force.

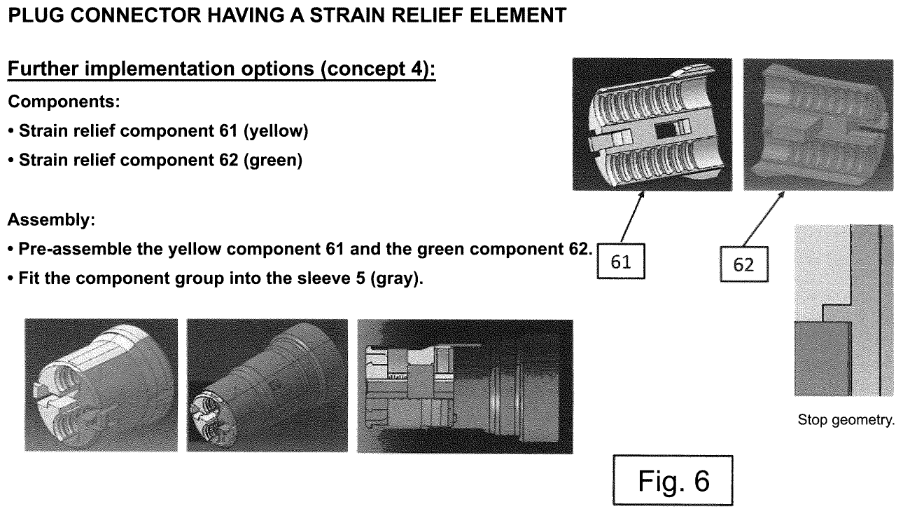

In contrast to the components 61, 62 of the three concepts described above, which are held together by means of the respective spring element, a further concept is shown in FIG. 6. In this case, the corresponding geometries of the two components 61, 62 ensure that these two components 61, 62 cannot move relative to each other when inserted into the sleeve 5. These corresponding geometries are, for example, a recess in one component that interacts with a corresponding projection on the other component.

In all four concepts shown and described above, the components 61, 62 have locking tabs that can interact with the sleeve 5 and/or the contact carrier 3 and/or the outer housing 7 for the purpose of fixation.

Alternatively or in addition to the fixation of the at least two strain relief components 61, 62 by means of spring force or locking force in the sleeve 5 or by deformation, such as pressing (in particular crimping), of the sleeve 5, it is possible to consider gluing the strain relief components 61, 62 in the sleeve 5. This also keeps tensile and/or compressive forces away from the contacts 2 when the sleeve 5 is supported on the contact carrier 3.

Strain relief element=strain relief element=strain relief component

### LIST OF REFERENCE SIGNS

1. Cable
2. Contact
3. Contact support
4. Latch
5. Sleeve
6. Strain relief element
61. First component
62. Further component
63. Spring element
64. Ball
65. Wave-shaped spring element
7. Outer housing
8. Shielding cage
9. Seal
10. One end of the outer housing
11. Sealing plug

1. A plug connector having a strain relief element, wherein each contact (2) of the plug connector is disposed in a contact chamber of a contact carrier (3), wherein each contact (2) is fastened to the end of an electrical conductor of a cable (1), wherein tensile and/or compressive forces which can act on the contact (2) via the cable (1) are largely or completely kept away from the contact (2) by means of the strain relief element, characterized in that a sleeve (5) is provided, into which the contact carrier (3) is inserted, wherein a first and at least one additional strain relief component (61, 62) are inserted within the sleeve (5), wherein the inner contour of the at least two strain relief components (61, 62) acts on the at least one cable (1), preferably a plurality of cables (1), and the strain relief components (61, 62) are supported on the contact carrier (3) by means of the sleeve (5) so that tensile and/or compressive forces acting on the at least one cable (1) are kept away from the contacts (2).

2. The plug connector according to claim 1, characterized in that exactly two strain relief components (61, 62) are inserted into the sleeve (5).

3. The plug connector according to claim 1 or 2, characterized in that two components (61, 62) are provided as strain relief components, which have an inner contour with elevations and depressions which alternate in the axial course in order to bring about good contact with the outer sheath of the at least one cable (1) when they are enclosed by the two components (61, 62) under the influence of pressure, wherein the two components (61, 62) are held together by means of at least one spring element (63), preferably by means of two spring elements (63).

4. The plug connector according to claim 1 or 2, characterized in that two components (61, 62) are provided as strain relief components, which have an inner contour with elevations and depressions which alternate in the axial course in order to bring about good contact with the outer sheath of the at least one cable (1) when they are enclosed by the two components (61, 62) under the influence of pressure, wherein the two components (61, 62) are held together by means of at least one spring element designed as a ball (64), wherein the ball (64) causes the two components (61, 62) to be unable to move relative to one another when they are inserted together into the sleeve (5).

5. The plug connector according to claim 1 or 2, characterized in that two components (61, 62) are provided as strain relief components, which have an inner contour with elevations and depressions which alternate in the axial course in order to bring about good contact with the outer sheath of the at least one cable (1) when these are enclosed by the two components (61, 62) under the influence of pressure, wherein the two components (61, 62) are held together by means of at least one wave-shaped spring element (65), wherein the spring element (65) causes the two components (61, 62) to be held together when they are inserted into the sleeve (5).

6. The plug connector according to claim 1 or 2, characterized in that two components (61, 62) are provided as strain relief components, which have an inner contour with elevations and depressions which alternate in the axial course in order to bring about good contact with the outer sheath of the at least one cable (1) when they are enclosed by the two components (61, 62) under the influence of pressure, wherein the two components (61, 62) have geometries which correspond to one another and it is ensured by the geometries of the two components (61, 62) that correspond to on another that these two components (61, 62) cannot move relative to one another when inserted into the sleeve (5).

7. The plug connector according to one of the preceding claims, characterized in that the sleeve (5) with its contact carrier (3) is inserted into an outer housing (7).

8. The plug connector according to claim 7, characterized in that the outer housing (7) is surrounded by a shielding cage (8).

9. The plug connector according to claim 7 or 8, characterized in that a seal (9) is provided which is inserted into one end (10) of the outer housing (7).

10. The plug connector according to claim 9, characterized in that a sealing plug (11) is provided which fixes the seal (9) in the end (10) of the outer housing (7) and through which the at least one cable (1) is passed.
